(19) United States
(12) Patent Application Publication
(10) Pub. No.: US 2010/0208401 A1
(43) Pub. Date: Aug. 19, 2010

(54) INDUCTIVE LOAD DRIVING CIRCUIT

(75) Inventor: Kazuhiro Kimoto, Yokkaichi-shi (JP)

Correspondence Address: OLIFF & BERRIDGE, PLC, P.O. BOX 320850, ALEXANDRIA, VA, 22320-4850, US

(73) Assignees: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka-shi (JP)

(21) Appl. No.: 12/734,138

(22) PCT Filed: Aug. 10, 2009
(86) PCT No.: PCT/JP2009/064101

§ 371 Date: Apr. 13, 2010

(30) Foreign Application Priority Data
Aug. 11, 2008 (JP) 2008-207332

(51) Int. Cl. H02H 3/26

(52) U.S. Cl. 361/77

(57) ABSTRACT

An inductive load driving circuit includes a control circuit and a protection circuit. The control circuit controls switching operation of a switching circuit. In normal connection of a battery, the switching circuit switches current-carrying to an inductive load between on and off. In reverse connection of the battery, the switching circuit can carry current in a direction reverse to a direction in the normal battery connection. The protection circuit has a current breaker that conducts at least at switching of the current-carrying from on to off by the switching circuit in normal battery connection and, in the reverse battery connection, does not conduct according to the reverse battery connection.

### TECHNICAL FIELD

The present invention relates to inductive load driving circuits or, specifically, to an inductive load driving circuit including a protective function against reverse battery connection.

### BACKGROUND ART

Conventionally, in a case where an inductive load is driven, a back-flow circuit using a diode is used as a surge voltage protection circuit. Furthermore, in a case where a current value of the inductive load is larger, a MOSFET is typically used as a driving device. However, in a case where the inductive load is for use in a vehicle, reverse connection of the battery (the power source) is conceivable. In the reverse battery connection, there is a potential for a large current to flow through a freewheeling diode and a body diode (a parasitic diode) of the MOSFET to damage the freewheeling diode, the MOSFET, and the wiring.

Therefore, in order to avoid such a trouble in the reverse battery connection, a MOSFET is conventionally inserted in a battery supply line (a load current supply line) as disclosed in, for example, Japanese Unexamined Patent Application Publication No. 2-179223. Furthermore, an art to insert a diode or a mechanical relay is conventionally known.

However, in such a method with the MOSFET etc. inserted in the battery supply line to prevent the large current in the reverse battery connection, a predetermined current flows through the inserted MOSFET also in a normal state, which causes inconvenient extra power consumption. Furthermore, in a case where the mechanical relay is used, the component size is inconveniently larger.

The present invention was completed on a basis of the circumstances as above, and its object is to provide an inductive load driving circuit that consumes less power in the normal state while can suitably prevent generation of the large current in the reverse battery connection.

### DISCLOSURE OF THE INVENTION

As a means for achieving the above-described object, an aspect of an inductive load driving circuit includes a switching circuit provided between a battery and an inductive load. In normal battery connection, the switching circuit switches current-carrying to the inductive load between on and off, and, in reverse battery connection, the switching circuit is capable of carrying current in a direction reverse to a direction in the normal battery connection. The inductive load driving circuit also includes a control circuit that controls the switching on and off operation of the switching circuit; and a protection circuit connected in parallel with the inductive load and having a current breaker. The breaker conducts at least at the switching of the current-carrying to the inductive load from on to off by the switching circuit in the normal battery connection, and, in the reverse battery connection, the breaker does not conduct according to the reverse battery connection.

With the configuration of this aspect, in the normal battery connection, a surge current by the inductive load when the current-carrying is switched from on to off by the switching circuit can be flown back while, when the current-carrying to the inductive load is on, the protection circuit can be put in an non-conductive state so that the power consumption is less. Moreover, in the reverse battery connection, the current breaker of the protection circuit does not conduct according to the reverse battery connection or, in other words, detects the reverse battery connection by itself and does not conduct. At this time, in the reverse battery connection, a predetermined reverse connection current flows through the inductive load, which is connected in parallel with the protection circuit, and the switching circuit. Accordingly, in the reverse battery connection, generation of a large current due to short circuit etc. can be suitably prevented. Furthermore, because it is unnecessary to separately provide a circuit to detect the reverse battery connection, the configuration of the protection circuit can be simpler.

### BRIEF DESCRIPTION OF THE DRAWINGS

FIG. 1 is a schematic block diagram of an inductive load driving circuit of a first embodiment in accordance with the present invention, the diagram being in normal battery connection;

FIG. 2 is a time chart in the normal battery connection in the first embodiment;

FIG. 3 is a schematic block diagram of the inductive load driving circuit of the first embodiment, the diagram being in reverse battery connection;

FIG. 4 is a time chart in the reverse battery connection in the first embodiment;

FIG. 5 is a schematic block diagram of the inductive load driving circuit of a second embodiment, the diagram being in the normal battery connection;

FIG. 6 is a schematic block diagram of the inductive load driving circuit of the second embodiment, the diagram being in the reverse battery connection;

FIG. 7 is a schematic block diagram of the inductive load driving circuit of a third embodiment, the diagram being in the normal battery connection; and

FIG. 8 is a schematic block diagram of the inductive load driving circuit of the third embodiment, the diagram being in the reverse battery connection.

### EXPLANATION OF REFERENCE CHARACTERS

10 . . . inductive load driving circuit
11 . . . control circuit
12 . . . N-channel MOSFET (switching circuit)
12A . . . parasitic diode
13, 13A, 13B . . . protection circuit
D1, D2, D3 . . . freewheeling diode (diode)
R1 . . . first resistor
R2 . . . second resistor
Q1 . . . NPN bipolar transistor (transistor, current breaker)
Q2 . . . N-channel MOSFET (field effect transistor, current breaker)
Ba . . . battery
L . . . exciting coil
M . . . inductive load
RLY . . . relay
SP . . . contact member (current breaker)

### BEST MODE FOR CARRYING OUT THE INVENTION

### First Embodiment

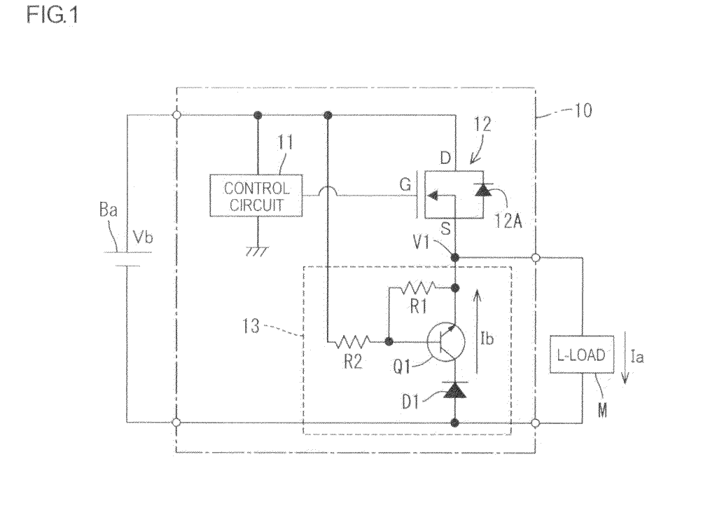

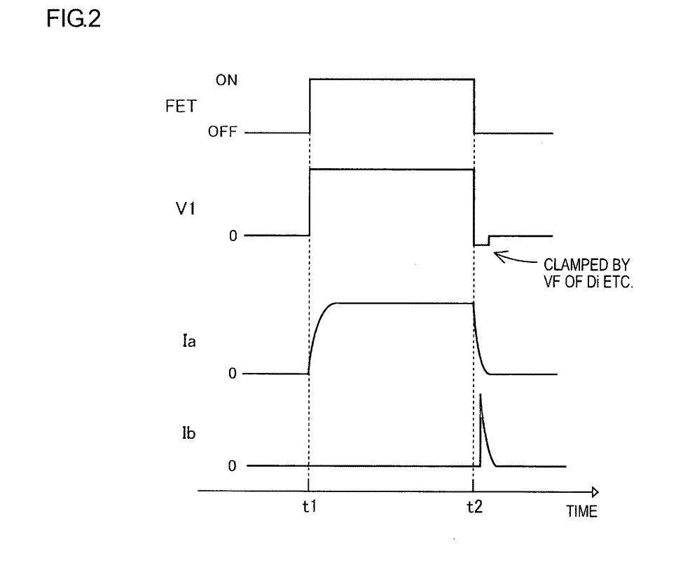

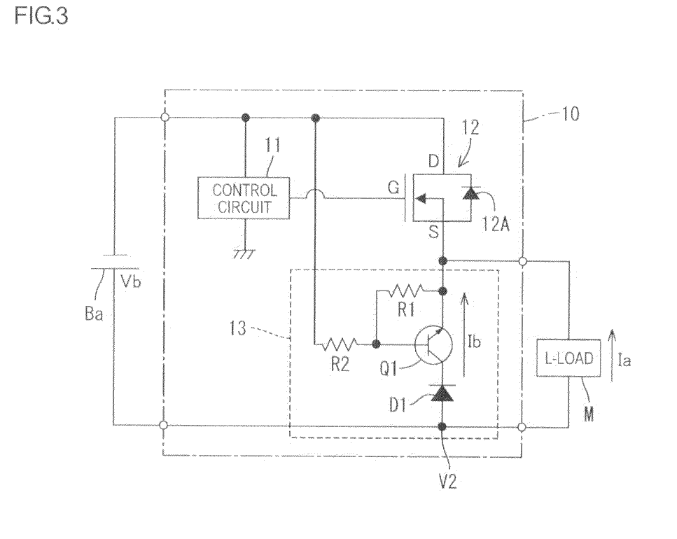

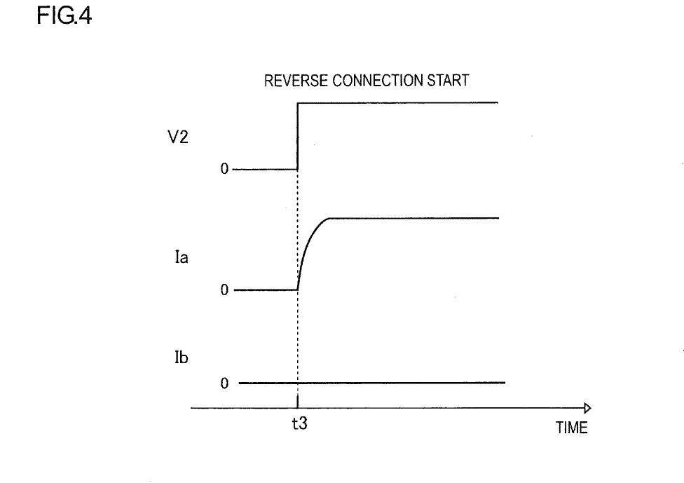

A first embodiment in accordance with the present invention will be described with reference to FIGS. 1 through 4. FIG. 1 is a schematic block diagram of an inductive load driving circuit 10 of the first embodiment in accordance with the present invention, the diagram being in normal battery connection. FIG. 2 is a time chart in the normal battery connection. FIG. 3 is a schematic block diagram of the inductive load driving circuit 10 in reverse battery connection. FIG. 4 is a time chart in the reverse battery connection.

The inductive load driving circuit 10 includes a control circuit 11, a switching circuit 12, and a protection circuit 13. In this embodiment, the inductive load driving circuit 10 is equipped in an automobile and is connected between a battery Ba and an inductive load M (for example, an engine cooling FAN drive motor) so as to operate drive control of the inductive load M.

The control circuit 11 includes, for example, a CPU and controls switching (on/off) operation of the switching circuit 12 with a PWM (pulse width modulation) signal. To control the switching operation, the control circuit 10 modulates the duty ratio (the pulse width) of the PWM signal as required in accordance with the inductive load M.

The switching circuit 12 is provided between the battery Ba and the inductive load M. The switching circuit 12 is configured by, for example, an N-channel MOSFET including a parasitic diode 12A, as illustrated in FIG. 1. In the case where the battery Ba is normally connected, the switching circuit 12 switches the current-carrying to the inductive load M between on and off according to the PWM signal that is supplied to a gate G. In the case of the reverse connection of the battery Ba, the switching circuit 12 can carry the current in a direction through the parasitic diode 12A, the direction being reverse to a direction in the normal connection of the battery Ba.

As illustrated in FIG. 1, the protection circuit 13 is connected to the switching circuit 12. The protection circuit 13 includes a transistor (an NPN bipolar transistor) Q1, a diode (a freewheeling diode) D1, a first resistor R1, and a second resistor R2.

The emitter of the transistor (an illustration of a current breaker) Q1 is connected to the switching circuit 12 or, specifically, to a source S of the N-channel MOSFET. The collector of the transistor Q1 is connected to the cathode of the diode D1. The base of the transistor Q1 is connected to the high-voltage side (in the normal connection of the battery Ba) via the second resistor R2.

Furthermore, the first resistor R1 is connected between the base and the emitter of the transistor Q1. The anode of the diode D1 is, in the normal connection of the battery Ba, connected to the low-voltage side of the battery Ba, i.e. is grounded.

Note here that the first resistor R1 and the second resistor R2 have respective values that are set so that the transistor Q1 is turned on at the switching of the current-carrying to the inductive load M from on to off by the switching circuit 12 in the normal connection of the battery Ba. In a case where the battery voltage Vb is 12 V, the values of the first resistor R1 and the second resistor R2 are, for example, 1 (one) KΩ each.

Accordingly, in the protection circuit 13, in the normal connection of the battery Ba, the freewheeling diode D1 prevents the load current from flowing into the protection circuit 13. Moreover, at the switching of the current-carrying to the inductive load M from on to off by the switching circuit 12 in the normal connection of the battery Ba, the collector-emitter path of the transistor Q1 conducts. This can allow a surge current (a protection circuit current) Ib due to a counter electromotive voltage of the inductive load M to flow back through the transistor Q1.

That is, in the normal connection of the battery Ba, as illustrated in the time chart of FIG. 2, upon switching on of the FET 12 at a time point t1 in FIG. 2, a voltage V1 at a node between the switching circuit 12 and the protection circuit 13 increases substantially up to the battery voltage Vb, and a load current Ia is supplied to the inductive load M. Then, upon switching off of the FET 12 at a time point t2 in FIG. 2, the load current Ia decreases and, accompanying this, the counter electromotive voltage (the negative surge) is generated in the inductive load M, and the potential of the node voltage V1 becomes negative. The counter electromotive voltage is clamped by a forward voltage drop VF of the freewheeling diode D1 and the ON-state voltage of the transistor Q1, and this clamped voltage causes the surge current Ib to momentarily flow through the protection circuit 13. Thus, the counter electromotive voltage is absorbed.

On the other hand, in the reverse connection of the battery Ba, the protection circuit does not conduct. That is, as illustrated in the time chart of FIG. 4, upon the reverse connection of the battery Ba at a time point t3 in FIG. 4, an anode voltage V2 of the freewheeling diode D1 increases up to the battery voltage Vb. Furthermore, the second resistor R2 is connected to the low voltage side of the battery Ba (see FIG. 3). Accordingly, because the base voltage of the transistor Q1 becomes neither equal to nor higher than the emitter voltage, the transistor Q1 is not turned on, and the reverse connection current (the protection circuit current) IB due to the reverse connection of the battery Ba does not flow. At this time, the load current Ia in a direction flows through the inductive load M and the parasitic diode 12A, the direction being reverse to a direction in the normal battery connection (see FIGS. 3 and 4).

That is, even in the case where the battery Ba is reversely connected, the predetermined load current Ia depending on the resistance of the inductive load M flows, while a large current such as a short-circuit current is not generated. Therefore, damage to the switching circuit (a FET element) 12, the wiring, etc. is avoided.

<Effect of First Embodiment>

As described above, in the first embodiment, the protection circuit 13 or, specifically, the collector-emitter path of the transistor Q1 conducts only at the generation of the surge voltage due to the inductive load M in the normal battery connection, while does not conduct in the reverse battery connection. That is, when the inductive load M is being driven with the battery Ba, in the normal state, power consumption can be less, while the counter electromotive voltage of the inductive load M can be suitably absorbed; moreover, in the reverse battery connection, the generation of the large current can be suitably prevented.

Furthermore, the protection circuit 13 is configured to turn off the collector-emitter path of the transistor Q1 according to the reverse connection of the battery Ba, i.e. by detecting the reverse connection of the battery Ba by itself. Therefore, it is unnecessary to separately provide a circuit to detect the reverse battery connection. Accordingly, the configuration of the protection circuit can be simpler.

Furthermore, the protection circuit 13 is configured simply only by the transistor Q1, the diode D1, the first resistor R1, and the second resistor R2. Thus, the above-described effect can be produced with the simpler configuration. In addition to this, because the transistor Q1 is not provided in the battery supply line (the load current supply line), a low-power and small-size bipolar transistor can be used as the transistor Q1. That is, the parts count of the protection circuit 13 can be less, and miniaturization is possible.

### Second Embodiment

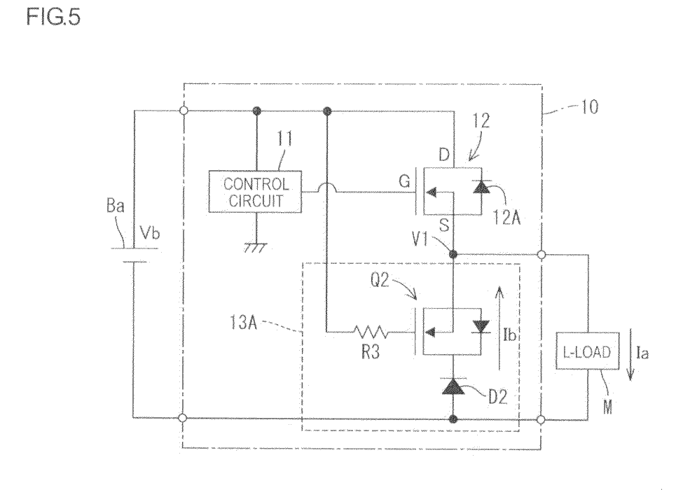

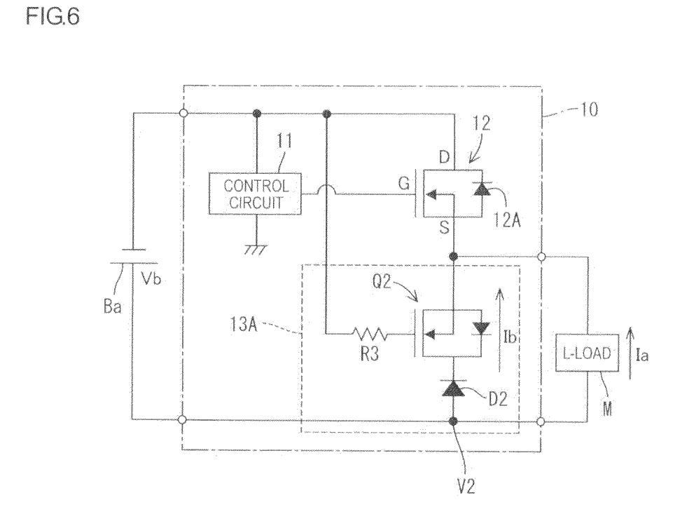

Next, a second embodiment in accordance with the present invention will be described with reference to FIGS. 2, 4, 5, and 6. FIG. 5 is a schematic block diagram of the inductive load driving circuit 10 of the second embodiment, the diagram being in the normal battery connection. FIG. 6 is a schematic block diagram of the inductive load driving circuit 10 of the second embodiment, the diagram being in the reverse battery connection. Note that the configuration identical with the first embodiment will be designated with the identical reference characters, while the description will be omitted. Furthermore, because the configuration of the inductive load driving circuit 10 of the second embodiment differs from that of the first embodiment only in the configuration of the protection circuit, only the differences in the protection circuit will be described.

As illustrated in FIG. 5, a protection circuit 13A of the inductive load driving circuit 10 of the second embodiment includes a field effect transistor (an N-channel MOSFET) Q2, a diode (a freewheeling diode) D2, and a resistor R3. That is, in the protection circuit 13A of the second embodiment, the NPN bipolar transistor Q1 of the protection circuit 13 of the first embodiment is replaced with the N-channel MOSFET (an illustration of the current breaker) Q2.

The source of the field effect transistor Q2 is connected to the switching circuit 12 or, specifically, to the source S of the FET element 12. The drain of the field effect transistor Q2 is connected to the cathode of the diode D2. The gate of the field effect transistor Q2 is connected to the high-voltage side of the battery Ba (in the normal connection of the battery Ba) via the resistor R3. Furthermore, the anode of the diode D2 is, in the normal connection of the battery Ba, connected to the low-voltage side of the battery, i.e. is grounded.

With this configuration, the field effect transistor Q2 is, in the normal connection of the battery Ba, turned on by the battery voltage Vb applied via the resistor R3 only at the switching of the current-carrying from on to off by the switching circuit 12. Moreover, the field effect transistor Q2 is turned off in the reverse connection of the battery Ba.

Because of this, in the protection circuit 13A, in the normal connection of the battery Ba, the freewheeling diode D2 prevents the load current from flowing into the protection circuit 13A. Moreover, at the switching of the current-carrying to the inductive load M from on to off by the switching circuit 12 in the normal connection of the battery Ba, a drain-source path of the transistor Q2 conducts. This can allow the surge current (the protection circuit current) Ib due to the counter electromotive voltage of the inductive load M to flow back through the transistor Q2.

That is, similar to the first embodiment, in the normal connection of the battery Ba, as illustrated in the time chart of FIG. 2, upon turning on of the FET 12 at the time point t1, the voltage V1 at a node between the FET 12 and the protection circuit 13A increases substantially up to the battery voltage Vb, and the load current Ia is supplied to the inductive load M. Then, upon turning off of the FET 12 at the time point t2 in FIG. 2, the load current Ia decreases and, accompanying this, the counter electromotive voltage (the negative surge) is generated in the inductive load M, while the potential of the node voltage V1 becomes negative. The counter electromotive voltage is clamped by the forward voltage drop VF of the freewheeling diode D2 and the ON-state voltage of the transistor Q2, and this clamped voltage causes the surge current Ib to momentarily flow through the transistor Q2 of the protection circuit 13A. Thus, the counter electromotive voltage is absorbed.

On the other hand, in the reverse connection of the battery Ba, the protection circuit 13A does not conduct. That is, as illustrated in the time chart of FIG. 4, upon the reverse connection of the battery Ba at a time point t3 in FIG. 4, the anode voltage of the freewheeling diode D2 increases up to the battery voltage Vb. Moreover, the resistor R3 is connected to the low-voltage side of the battery Ba (see FIG. 6). Accordingly, because the gate voltage of the transistor Q2 becomes neither equal to nor higher than the source voltage, the transistor Q2 is not turned on, and the reverse connection current (the protection circuit current) Ib due to the reverse connection of the battery Ba does not flow. At this time, the load current Ia in the direction reverse to the direction in the normal battery connection flows through the inductive load M and the parasitic diode 12A (see FIG. 6).

That is, even in the case of the reverse connection of the battery Ba, the predetermined load current Ia depending on the resistance value of the inductive load M flows, while the large current such as the short-circuit current is not generated in the inductive load driving circuit 10. Therefore, damage to the switching circuit (the FET element) 12, the wiring, etc. is avoided.

<Effect of the Second Embodiment>

As described above, the second embodiment also can produce an effect similar to that of the first embodiment. Furthermore, because the number of the resistors in the protection circuit can be less, the parts count of the protection circuit can be still less, and miniaturization is possible.

### Third Embodiment

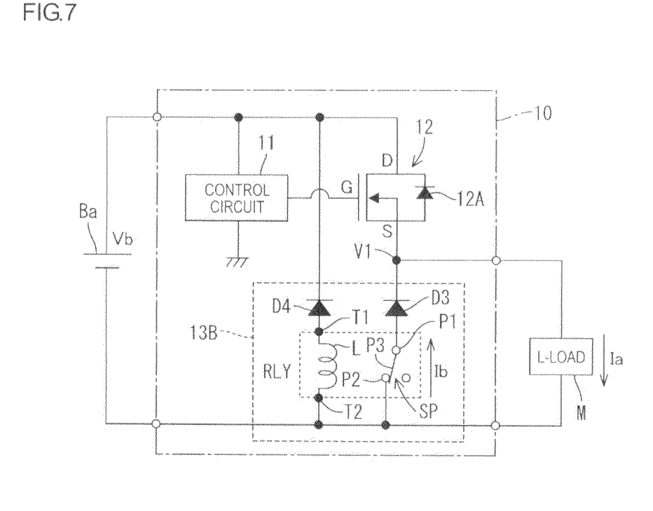

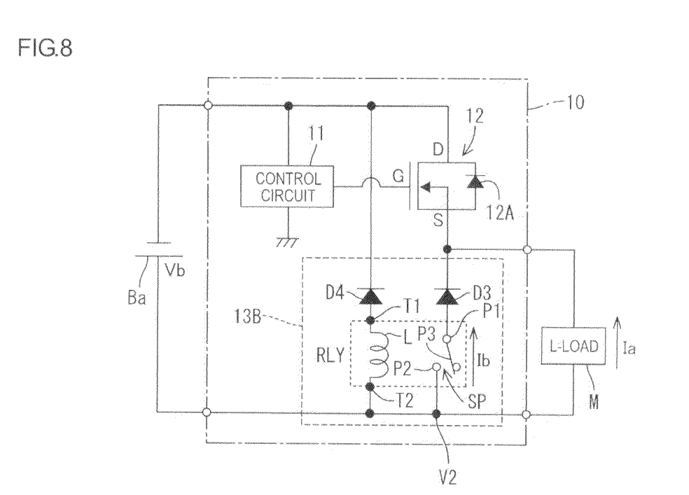

Next, a third embodiment in accordance with the present invention will be described with reference to FIGS. 2, 4, 7, and 8. FIG. 7 is a schematic block diagram of the inductive load driving circuit 10 of the third embodiment, the diagram being in the normal battery connection. FIG. 8 is a schematic block diagram of the inductive load driving circuit 10 of the second embodiment, the diagram being in the reverse battery connection. Note that the configuration identical with the first embodiment will be designated with the identical reference characters, while the description will be omitted. Furthermore, because the configuration of the inductive load driving circuit 10 of the third embodiment differs from that of the first embodiment only in the protection circuit, only the differences in the protection circuit will be described.

As illustrated in FIG. 7, a protection circuit 13B of the third embodiment includes a relay RLY, a first diode (a freewheeling diode) D3, and a second diode D4. The relay RLY includes an exciting coil L and a normally closed contact member (an illustration of the current breaker) SP. The exciting coil L has a first terminal T1 and a second terminal T2. The contact member SP has a first contact P1 and a second contact P2. The first contact P1 and the second contact P2 are connected together or disconnected from each other via a movable piece P3. When the exciting coil L is not excited, the first contact P1 and the second contact P2 are connected together via the movable piece P3.

The anode of the first diode D3 is connected to the first contact P1 of the contact member SP. The cathode of the first diode D3 is connected to the switching circuit 12 or, specifically, to the source S of the FET element 12. The cathode of the second diode D4 is connected to the high-voltage side of the battery (in the normal battery connection). The anode of the second diode D4 is connected to the first terminal T1 of the exciting coil L. Moreover, the second terminal T2 of the exciting coil L and the second contact P2 of the contact member Sp are, in the normal connection of the battery Ba, connected to the low-voltage side of the battery Ba, i.e. is grounded.

With this configuration, in the normal connection of the battery Ba, because the second diode D4 prevents the current from the battery Ba, the exciting coil L is not excited by the voltage Vb of the battery Ba, so that the contact member SP is in the conductive state. On the other hand, in the reverse connection of the battery Ba, the exciting coil L is excited by the battery voltage Vb, so that the conduction of the contact member SP is broken.

Accordingly, in the protection circuit 13B, in the normal connection of the battery Ba, the freewheeling diode D3 prevents the load current from flowing into the protection circuit 13B. Moreover, at the switching of the current-carrying to the inductive load M from on to off by the switching circuit 12 in the normal connection of the battery Ba, the contact member SP of the relay RLY is in the conductive state. This can allow the surge current (the protection circuit current) Ib due to the counter electromotive voltage of the inductive load M to flow back through the contact member SP.

That is, similar to the first embodiment, in the normal connection of the battery Ba, as illustrated in the time chart of FIG. 2, upon turning on of the FET 12 at the time point t1, the voltage V1 at a node between the FET 12 and the protection circuit 13B increases substantially up to the battery voltage Vb, and the load current Ia is supplied to the inductive load M. Then, upon turning off of the FET 12 at the time point t2 in FIG. 2, the load current Ia decreases and, accompanying this, the counter electromotive voltage is generated in the inductive load M. The counter electromotive voltage causes the surge current Ib to momentarily flow through the transistor Q2 of the protection circuit 13B. Thus, the counter electromotive voltage is absorbed.

On the other hand, in the reverse connection of the battery Ba, the conduction of the contact member SP in the protection circuit 13B is broken. That is, as illustrated in the time chart of FIG. 4, upon the reverse connection of the battery Ba at the time point t3 in FIG. 4, the voltage V2 of the second terminal T2 of the exciting coil L increases up to the battery voltage Vb, and the exciting coil L is excited. Accompanying the excitation of the exciting coil L, the movable piece P3 of the contact member SP removes from the second contact P2. That is, the connection between the first contact P1 and the second contact P2 of the contact member SP is turned off (see FIG. 8). Accordingly, the surge current (the protection circuit current) Ib due to the reverse connection of the battery Ba does not flow. At this time, the load current Ia in the direction reverse to the direction in the normal battery connection flows through the inductive load M and the parasitic diode 12A (see FIG. 8).

That is, even in the reverse connection of the battery Ba, the predetermined load current Ia depending on the resistance value of the inductive load M flows, and the large current such as the short-circuit current is not generated in the inductive load driving circuit 10. Therefore, damage to the switching circuit (the FET element) 12, the wiring, etc. in the reverse battery connection is avoided.

<Effect of the Third Embodiment>

As described above, also in the third embodiment, in the normal battery connection, the protection circuit 13B or, specifically, the contact member SP of the relay RLY conducts and, only at the generation of the surge voltage, the surge current flows through the contact member SP. On the other hand, in the reverse battery connection, the exciting coil L is excited, so that the contact member SP of the relay RLY does not conduct. That is, when the inductive load M is driven with the battery Ba, in the normal state, power consumption can be less, while the counter electromotive voltage of the inductive load M can be suitably absorbed; and moreover, in the reverse battery connection, generation of the large current can be suitably prevented.

Furthermore, the protection circuit 13B is configured simply only by the relay RLY, the first diode D3, and the second diode D9. Therefore, the above-described effect can be produced with the simpler configuration. In addition to this, because the relay RLY is not provided in the battery supply line, a low-power and small-size relay RLY can be used as the relay RLY.

### Other Embodiments

The present invention is not limited to the above description with reference to the drawings; for example, following embodiments are also included within the scope of the present invention.

(1) The configuration of the protection circuit is not limited to the configuration of the protection circuits (13-13B) of the first through third embodiments. Essentially, it is only necessary for the protection circuit to be a protection circuit that is connected in parallel with the inductive load and to have the current breaker that conducts at least at the switching of the current-carrying from on to off by the switching circuit in the normal battery connection while, in the reverse battery connection, does not conduct according to the reverse battery connection, i.e. detects the reverse battery connection by itself and does not conduct.

(2) The above-described embodiments are illustrations of a case where the inductive load driving circuit 10 is illustratively equipped in the automobile and drives the engine cooling FAN drive motor as the inductive load M. The inductive load driving circuit in accordance with the present invention can be adapted to any case where the inductive load driving circuit is disposed between the battery Ba and the inductive load M.

1. An inductive load driving circuit comprising:
a switching circuit provided between a battery and an inductive load, wherein, in normal battery connection, the switching circuit switches current-carrying to the inductive load between on and off, and, in reverse battery connection, the switching circuit is capable of carrying current in a direction reverse to a direction in the normal battery connection;
a control circuit that controls the switching on and off operation of the switching circuit; and
a protection circuit connected in parallel with the inductive load and having a current breaker,
wherein:
the current breaker conducts at least at the switching of the current-carrying to the inductive load from on to off by the switching circuit in the normal battery connection, and
in the reverse battery connection, the current breaker does not conduct according to the reverse battery connection.

2. The inductive load driving circuit according to claim 1, wherein:
the protection circuit includes a transistor as the current breaker, a diode, a first resistor, and a second resistor;
an emitter of the transistor is connected to the switching circuit, a collector of the transistor is connected to the diode, and a base of the transistor is, in the normal battery connection, connected to a high-voltage side of the battery via the second resistor;
the first resistor is connected between the base and the emitter of the transistor;
a cathode of the diode is connected to the collector of the transistor, and an anode of the diode is, in the normal battery connection, connected to a low-voltage side of the battery;
the first resistor and the second resistor has respective values that are set so that the transistor is turned on at the switching of the current-carrying from on to off by the switching circuit in the normal battery connection; and
in the reverse battery connection, the transistor is turned off according to the reverse battery connection.

3. The inductive load driving circuit according to claim 1, wherein:
the protection circuit includes a field effect transistor as the current breaker, a diode, and a resistor;
a source of the field effect transistor is connected to the switching circuit, a drain of the field effect transistor is connected to the diode, and a gate of the field effect transistor is, in the normal battery connection, connected to a high-voltage side of the battery;
a cathode of the diode is connected to the drain, and an anode of the diode is, in the normal battery connection, connected to a low-voltage side of the battery;
the field effect transistor is turned on at the switching of the current-carrying from on to off by the switching circuit in the normal battery connection; and
in the reverse battery connection, the field effect transistor is turned off according to the reverse battery connection.

4. The inductive load driving circuit according to claim 1, wherein:
the protection circuit includes a relay, a first diode, and a second diode, the relay including an exciting coil and a contact member;
the exciting coil has a first and a second terminals;
the contact member is the current breaker and has a first and a second contacts;
an anode of the first diode is connected to the first contact of the contact member, and a cathode of the first diode is connected to the switching circuit;
a cathode of the second diode is, in the normal battery connection, connected to a high-voltage side of the battery, and an anode of the second diode is connected to the first terminal of the exciting coil;
the second terminal of the exciting coil and the second contact of the contact member is, in the normal battery connection, connected to a low-voltage side of the battery;
in the normal battery connection, the exciting coil is not excited by a voltage of the battery, and the contact member is in a conductive state; and
in the reverse battery connection, the exciting coil is excited according to the reverse battery connection, and the conduction of the contact member is broken.

5. The inductive load driving circuit according to claim 1, wherein the switching circuit includes a field effect transistor, and the control circuit on-off controls the field effect transistor with a PWM signal.
